(19) United States
(12) Patent Application Publication
(10) Pub. No.: US 2026/0355983 A1
(43) Pub. Date: Nov. 12, 2026

(54) ADAPTIVE CONNECTION MODULE FOR ROBOT ARMS, END-EFFECTOR SYSTEM FOR ROBOTS, ROBOTIC SYSTEM, AND SYS-TEM WITH SUCH A ROBOTIC SYSTEM

(71) Applicant: Langenstein & Schemann GmbH, Coburg (DE)

(72) Inventor: Harald Barnickel, Coburg (DE)

(21) Appl. No.: 19/671,136

(22) Filed: May 7, 2026

(30) Foreign Application Priority Data
May 9, 2025 (DE) 10 2025 1170996.4

(51) Int. Cl. B25J 15/00; B25J 9/16; B25J 13/08; B25J 19/00

(52) U.S. Cl. CPC B25J 15/0066; B25J 9/1674; B25J 13/085; B25J 19/0091

(57) ABSTRACT

The invention relates in particular to an adaptive connection module for robot arms, an end-effector system for robots, and a robotic system. The adaptive connection module is arranged for mounting between a robot arm and an end effector and comprises a collision protection unit, a compliance unit connected in series therewith, a first mounting interface associated with the collision protection unit, and a second mounting interface associated with the compliance unit. The mounting interfaces are configured such that the adaptive connection module is to be connected via one of the mounting interfaces to a distal end of the robot arm and via the other mounting interface to the end effector. The collision protection unit comprises a sensor unit arranged to detect forces. The compliance unit provides adaptive coupling between the mounting interfaces. Upon recognition of a collision event, the robot arm can be stopped and moved to an initial position.

### FIELD OF THE INVENTION

The present invention relates to an adaptive connection module for robot arms, an end-effector system for robots, and a robotic system.

### BACKGROUND

The underlying invention relates in particular to the gripping or picking up of objects such as workpieces by a robot, more specifically by a robot arm, for example using a gripping tool mounted on the distal end of a robot arm. In particular, such robots with gripping systems are used for extraction (or: picking) of workpieces from a container or a bin (“reach-into-bin” or also known as “bin picking”).

In bin-picking applications, it is well known to determine the pose (or: spatial alignment/placement) of the workpiece to be picked using image recognition and to use the pose thus determined to control the robot arm. However, such image recognition systems are disadvantageous in that they exhibit a non-negligible degree of inaccuracy in determining the position, pose and/or orientation of the workpiece to be picked, e.g., during detection of the workpiece length and workpiece pose, which may have a certain tolerance depending on the specific application. For example, inaccuracies of as little as 2 mm or less can lead to errors in gripping the workpiece and/or collisions of the gripping tool with, for example, other workpieces. In the case of comparatively massive workpieces, such collisions can in particular also cause damage to the robot arm or the gripping tool. This can be the case in particular if, for example, the pose, position and/or orientation of a workpiece changes after it has been detected and the robot arm has been actuated accordingly. Such changes can be caused, for example, by the unstable pose of the workpiece in the container or by external vibrations, etc. Further potential causes of collisions can be inaccuracies and/or variations in the shape or geometric dimensions of workpieces. For example, in the field of forming and forging technology, it is relatively common for blanks provided and to be further processed by a forming or forging machine to deviate geometrically from a pre-programmed “optimal” geometry, such as a CAD geometry. A particular example of this are sheared blanks, which may exhibit significant deformations at the shear surface.

Although shutdown mechanisms for deactivating a robot arm following a collision (e.g., overload protection) are known, such shutdown systems typically cause the robot to come to a standstill and require a manual visual inspection or troubleshooting and resetting of the robot arm by an operating person. According to a finding of the invention, this is, on the one hand, time-consuming and, on the other hand, leads to interruptions in the processing sequence.

In the field of shutdown mechanisms for robot arms in the event of a collision, collision protection elements are known that provide a form of overload protection. Such overload protection serves to limit the forces acting on the robot arm in the event of a collision, for example by causing the colliding gripping tool to pivot relative to the robot arm when a maximum force is exceeded. This takes particularly into account the fact that, as a result of a detected collision and an immediately commanded emergency stop, robot arms generally have a follow-through due to control response times and moments of inertia, which can cause considerable forces to occur in the event of a collision.

From all this, it is clear that, in light of the invention, existing bin-picking systems have significant room for improvement, particularly with regard to the griping or picking up of workpieces and in terms of collision behavior.

Based thereon, the underlying invention is intended to avoid or mitigate the drawbacks of prior art, particularly in bin-picking applications. Specifically, the invention provides an improved robotic system, as well as a robotic end-effector system and an adaptive connection module, which are arranged to (or: configured to) at least largely avoid or even eliminate the drawbacks of the prior art.

This problem is solved by the features of claims 1, 7, and 12. Further embodiments result from the dependent claims and the following description.

In one embodiment, the underlying invention relates in particular to an adaptive connection module arranged to be mounted between a robot arm and an end effector (or: tool head) to be moved by the robot arm. The end effector is arranged to grip and/or hold, or generally to handle, an object, such as a workpiece, in particular a blank.

The robot arm is preferably a multiaxial robot arm arranged for industrial applications. The end effector may, for example, be a mechanical, pneumatic, and/or magnetic gripper for gripping, holding, and/or handling an object, in particular a workpiece.

In preferred embodiments, the robot arm or the adaptive connection module, respectively, is arranged for use in robotic arms for gripping and/or handling metallic workpieces, preferably blanks, for example in the context of forming or forging equipment. For example, handling the workpiece may include extraction of the workpiece from a container or a bin (“reach-into-bin” or “bin picking”), and/or feeding a machine or system for further processing or machining the workpiece, for example a blank. The handling may also include unloading a machine or system, for example a forming machine or forging machine.

The adaptive connection module comprises a collision protection unit (or: collision avoidance unit, collision prevention unit), a compliance unit (or: compensation unit) connected in series therewith (preferably directly), a first mounting interface (or: first attachment interface) associated with the collision protection unit, and a second mounting interface (or: second attachment interface) associated with the compliance unit.

The mounting interfaces are configured and arranged to connect the adaptive connection module to a distal end of the robot arm via one of the mounting interfaces and to the end effector via the other mounting interface, such that, when assembled, the collision protection unit and the compliance unit are connected in series between the distal end of the robot arm and the end effector.

In preferred embodiments, the first mounting interface may, for example, be attached directly to the collision protection unit and/or configured thereon. The second mounting interface may, in preferred embodiments, be attached to the compliance unit and/or configured thereon. In some embodiments, the mounting interfaces may be configured as mounting flanges or mounting surfaces. For mounting the adaptive connection module to the robot arm on the one hand and the end effector on the other, detachable connections, such as screw fastening elements, may be used. The distal end of the robot arm and the end effector may have corresponding complementary mounting interfaces.

Preferably, the adaptive connection module is configured and arranged in such a way that it can be installed between the distal end of the robot arm and the end effector while using (or continuing to use) existing robot arms and/or end effectors and the corresponding mounting interfaces on the robot arm and/or end effector. In particular, this means that the adaptive connection module proposed herein can also be retrofitted or installed in existing robot systems that are already in operation.

The collision protection unit comprises a sensor unit arranged to recognize (or: detect) forces (which act on the adaptive connection module via the mounting interfaces, e.g., caused by external influences, and which are characteristic of a collision event at the end effector or at the distal end of the robot arm, respectively, e.g., a collision event of the end effector with an external component), mechanical moments, in particular torsional, tilting, and/or bending forces or moments, and/or changes in pose, changes in position, and/or movements characteristic of a collision event, for example of the adaptive connection module and/or the collision protection unit.

In advantageous embodiments, the sensor unit may comprise, for example, one or more force and/or moment sensors configured to generate sensor signals representative of forces and/or moments that are applied to or act upon the adaptive connection module via the mounting interfaces. To detect a change of pose, change of position, and/or movement, displacement measurement systems and/or proximity switches, for example, may be used for the sensor unit. If the adaptive connection module includes, for example, a load-relief element—which may be part of the compliance unit and/or the collision protection unit—it is possible to recognize collisions based on changes in pose, changes in position, and/or movements of the load-relief element. For example, it may be envisaged that the adaptive connection module, in particular the collision protection unit and/or the load-relief element, is/are arranged such that, in the event of a collision, e.g., based on a spring, a spring element, and/or an elastically resetting element, it/they is/are displaced and changes/change shape and/or pose. A movement, change of pose, and/or change of position can be determined, for example, by means of a displacement measuring system and/or by means of one or more proximity switches. In particular, it may be provided that a displacement measuring system and/or one or more proximity switches detect a departure from a prescribed position and/or a relative or absolute change of pose with respect to a prescribed position.

The collision protection unit, in particular the sensor unit, may be arranged to generate a signal for a control or steering unit to command an emergency stop for the robot arm, or to generate a control or steering signal to command the emergency stop, upon the recognition or detection of a collision event, such as the application of forces and/or moments characteristic of a collision. The sensor unit may, for example, be part of a control or steering unit for controlling or steering the movement of the robot arm or may constitute a control or steering unit for controlling or steering the movement of the robot arm. An emergency stop may, for example, be implemented by software-or hardware-based components (e.g., programmed or programmable controllers).

The compliance unit provides adaptive coupling between the mounting interfaces. Adaptive coupling should be understood, in particular, to mean that relative movement of the mounting interfaces with respect to one another is possible, such as compensatory movement. The compliance unit serves in particular to enable a relative movement, e.g., flexible or spring-like, of the mounting interfaces relative to one another in specific directions (e.g., tilting, rotating, stretching, and/or compression), so that in the event of inaccuracy in the positioning of the end effector relative to an object to be gripped or picked up by the end effector, a compensatory movement of the end effector toward correct positioning and orientation is possible. Consequently, the safety, precision, and adaptability of the robot during interaction with the object can be improved.

In preferred embodiments, the compliance unit is a mechanically passive compensation unit, for example comprising one or more elastic return elements, such as spring, and/or elastomer or rubber elements or bodies. The return elements may, for example, be arranged between two spaced-apart plates, plate bodies, or frames, which, when subjected to an external force, allow for a (slight) tilting and/or twisting of the plates, plate bodies, or frames relative to one another. The plates, plate bodies, or frames connected in series with the mounting interfaces thus allow for tilting and/or twisting of the mounting interfaces relative to one another. In general, the compliance unit allows for a change in the relative orientation of the mounting interfaces relative to one another, which in turn enables relative orientation of the end effector relative to the distal end of the robot arm. In particular, the compliance unit enables adaptive orientation of the mounting interfaces relative to one another if, for example, in a given application, the end effector is (e.g., slightly) misaligned with respect to the object or workpiece. Such misalignment may, for example, be caused by inaccuracies in the position and/or pose detection of the object or workpiece by an image capture system.

It is particularly advantageous if the forces and/or moments applied by the compliance unit to the adaptive connection module, as part of adjusting the orientation and/or position of the end effector to the object or workpiece to be gripped or handled, remain below the detection threshold or trigger threshold of the collision protection unit. This prevents any adjustments to the orientation and/or position of the end effector that may be necessary during operation from being recognized as a collision event by the compliance unit.

The adaptive connection module enables, in particular, the operation of a robot arm, e.g., for bin-picking problems, in which, on the one hand, inaccurate positioning of the end effector relative to the object or workpiece can be compensated for, particularly without increased or complicated steering or control expenditure, and in which, on the other hand, the robot arm is protected from collision damage caused by forces and/or moments resulting from a collision with external objects, such as other workpieces.

The connection module is therefore adaptive in a particular sense, i.e., it is an adaptive connection module, in that it enables multiple adaptations to (changed and/or unforeseen) environmental conditions, caused on the one hand, for example, by mispositioning of the end effector (e.g., due to inaccuracies in the optical pose and/or position determination of the objects or workpieces, or unforeseeable changes in the pose and/or position of the objects or workpieces) and, on the other hand, by collisions with external objects. In particular, safe and damage-free operation of a robot arm can be achieved.

In some embodiments, the sensor unit may be arranged to generate a collision signal when forces, mechanical moments, movements, changes in position, and/or changes in pose characteristic of a collision are recognized (or: detected). The sensor unit may comprise one or more sensors arranged to detect a corresponding mechanical moment, change in pose, change in position, or movement. The mechanical moment may in particular consist of rotational, tilting, or bending forces or moments, wherein corresponding sensors may be configured as force or moment sensors. Displacement measurement systems and/or proximity switches may be used to determine changes in pose, changes in position, and/or movements.

The sensor unit may, in particular, be arranged such that the collision signal is generated when a force acting on the adaptive connection module via the mounting interfaces, a moment acting on the adaptive connection module, detected movements, displacements, changes in position and/or changes in pose, etc., exceed a prescribed (or: predetermined) or prescribeable (or: predeterminable; in particular: ajustably prescribeable) threshold value (or: limit value), in particular a force or moment threshold value (e.g., threshold moment; torsional moment threshold; bending moment threshold) and/or a threshold value for movements, displacements, changes in position, and/or changes in pose. The threshold, or in the case of multiple threshold values (e.g., for bending, torsional, rotational, and tilting forces/moments, movements, displacements, changes in position, changes in pose, etc.), is particularly advantageously selected to be above those forces, moments, movements, displacements, changes in position, and/or changes in pose, etc., that may occur or arise during adaptive coupling via the compliance unit in (regular and collision-free) operation. This ensures that an adjustment of the pose, position, and/or orientation of the end effector performed by the compliance unit is not detected as a collision event. In practical applications, for example, it may be provided that the threshold lies above a maximum force or moment value and/or above a maximum occurring change in position, change in pose and/or movement of the adaptive coupling via the compliance unit. It can be particularly advantageous if the detection threshold for detecting a collision event is adjustable, which, for example, enables adaptation of the adaptive connection module to different application scenarios. In this context, it may also be advantageous if compliance components, such as springs and/or elastomer components (in particular rubber components), are adjustable in terms of compliance, or if these components are interchangeable and/or variable in position. This also enables the compliance to be adapted to the respective application. For example, if comparatively heavy or massive workpieces are to be handled, components with a correspondingly high modulus of elasticity and/or high spring constant can be used for the compliance module. When handling lighter or mechanically comparatively sensitive objects or workpieces, components with a correspondingly lower modulus of elasticity and/or lower spring constant can be used. The ability to make the threshold value of the collision protection unit adjustable is also advantageous in that the threshold value can be adjusted so that the inertial forces typically acting during the movement of the object by the robot arm remain below the threshold value and are therefore not recognized or detected as a collision event. Furthermore, it is possible to provide displacement measurement systems and/or proximity systems with variably adjustable trigger thresholds or threshold values.

In embodiments, the adaptive connection module may further comprise a signal processing unit arranged to generate and provide a control or steering signal in response to a collision event recognized or detected with respect to the end effector. The signal processing unit may comprise at least one sensor configured to perform collision event recognition. The control or steering signal may, for example, be adapted such that it causes or commands an emergency stop of the robot arm. The signal processing unit may, for example, be an integral part of the adaptive connection module or be configured as a unit separate from the collision unit and the compliance unit, in particular as an external unit, and may, for example, form part of the control or steering for the robot arm.

In embodiments, the control or steering signal, e.g., when executed and/or applied by a controller assigned to the robot arm, may be adapted such that it:
signals or represents a command for an immediate stop (or: emergency stop) of a current movement of the robot arm, and/or
signals or represents a command for a movement of the robot arm to the initial position, and/or
signals or represents a command for the robot arm to move to an initial position of a cyclic movement or a portion of a cyclic movement of the robot arm, and a command to repeat, in particular adaptively repeat, the movement of the robot arm starting from the initial position.

In particular, according to particularly preferred embodiments, the adaptive connection module may be arranged to trigger or command an emergency stop in the event of a collision event, followed by movement of the robot arm to an initial position. This offers the advantage that, apart from the temporary return to the initial position, the robotic system can operate essentially continuously with comparatively short interruption times, even when collisions occur, particularly in comparison to known systems in which, following an emergency stop, further operation is frozen and user intervention is required to return the system to an initial state that allows for continued operation.

One or more optical sensors, such as cameras or camera systems, may be available for determining the pose of the workpieces. The optical sensors may, for example, be arranged in a stationary position relative to the workpieces to be gripped and/or mounted on the robot arm and/or on the adaptive connection module. The optical sensors may, for example, be image and/or video sensors. In particular, one or more optical sensors may be provided and arranged and configured such that, for example, during stationary mounting or when mounted on the robot arm or on the adaptive connection module, they detect and/or recognize ambient objects; and/or detect and/or determine the position, orientation, and/or alignment of an object to be handled with the end effector. Based on data from the optical sensors, for example regarding the pose, position, and/or orientation of an object, workpiece, or component to be handled, a signal processing unit can determine control or steering signals for moving the robot arm and command the movement of the robot arm accordingly (or: control or steer it). If, for example, one or more of the optical sensors and/or an associated signal processing unit are arranged to perform recognition or detection of objects other than the workpieces, this data can also be used, for example, for collision avoidance.

The adaptive connection module offers (intrinsic) adaptability in embodiments using optical sensors, in view of possible inaccuracies in the optical determination or detection of objects, shape deviations in workpieces, potential limitations of the optical sensor's field of view in the specific application, unforeseen changes in the position, pose, or alignment of the object being handled due to vibrations or shocks, etc. Shape deviations in workpieces can, for example, result from preceding machining or processing steps, such as forming or forging processes (varying burr formation, changes in length, etc.).

In embodiments, the compliance unit may comprise one or more elastic and/or fluidic compensation units or bodies, particularly those with elastic and/or fluidic resetting mechanisms, specifically compliance elements. Such elements may include spring and/or elastomer components. In particular, spring systems, rubber buffer systems, and/or pneumatic and/or hydraulic systems may be used. The compliance elements are specifically arranged for this purpose and enable relative movement between the two mounting interfaces when, in the application, there is a deviation between the position and/or orientation of the object to be handled and the position and/or orientation of the end effector. The compliance elements enable compensation for such deviations by, for example, allowing corrective tilting, rotating, and/or pivoting movements. Preferably, the compliance elements are passive elements, such as springs or rubber buffers. In this context, “resetting” specifically means that the compliance elements return to their original shape and orientation after undergoing a deformation or displacement to compensate for a deviation.

In embodiments, the collision protection unit may, for example, in addition to or alongside sensor-based recognition or detection of a collision event, further comprise a mechanical trigger element which, upon the application of a collision force or a collision moment, causes a displacement opposite to the collision force or moment, in particular an elastic or fluidic displacement, preferably one that performs self-resetting deflection and/or a decoupling of the two mounting interfaces. The trigger element may be active, dynamic, or passive. In particular, the trigger element enables an emergency movement or an emergency displacement, for example in the manner of a freewheel, of the mounting interfaces relative to one another. Such an emergency displacement causes, for example, the continued movement of the robot arm, caused by inertial effects or respective response times, to be intercepted or compensated for in the event of a commanded emergency stop for a collision event, without collision-related damage occurring to the robot arm due to the inertia-induced continued movement during an emergency stop.

In embodiments, an end-effector system for robots is provided. The end-effector system for robots comprises at least one adaptive connection module according to one of the embodiments described herein. In preferred embodiments, the first mounting interface may be configured for mounting on a distal end of a robot arm, and the second mounting interface may be configured for mounting an end effector.

In embodiments, the end-effector system for robots further comprises an end effector, which is preferably mounted at the second mounting interface. The end effector may be a vacuum gripper, a magnetic gripper, a mechanical gripping system, or a combination thereof.

In particularly preferred embodiments, the end-effector system is arranged for bin picking (“reach-into-bin”) or for bin-picking applications.

In embodiments, a robotic system is provided. The robotic system comprises at least one robot arm, in particular a multiaxial robot arm, having a distal end to which, via an adaptive connection module according to one of the embodiments described herein, an end effector is mounted, or to which an end-effector system according to one of the embodiments described herein is mounted.

In embodiments of the robotic system, the system further comprises at least one control or steering unit, which may, for example, be the signal processing unit mentioned above, or which may, for example, be part of the signal processing unit, comprise the signal processing unit, or vice versa.

The control or steering unit is signal-connected to the sensor unit (the collision protection unit), wherein the sensor unit is arranged to generate a collision signal and transmit it to the control or steering unit upon recognition of a collision event, particularly one occurring during movement of the robot arm. The control or steering unit is arranged to stop the movement of the robot arm (emergency stop) and/or to move the robot arm and the end effector to a prescribed initial position in response to receiving the collision signal.

In embodiments, the control or steering unit is further arranged to, after moving the robot arm to the prescribed initial position, control (or: command) a further movement process or movement cycle of the robot arm, or at least a portion of such a movement process or movement cycle, starting from the initial position. This enables a reduction in downtime in the event of a detected collision event, since, unlike in known systems, user intervention to reset or reposition the robot arm is not necessarily required.

In particularly preferred embodiments, the robotic system is arranged as a bin-picking system for the extraction of an object, in particular a workpiece, from a container.

In embodiments, the end effector may comprise one or more mechanical, pneumatic, and/or magnetic handling units, in particular grippers or gripping arrangements. Suitable examples include, in particular, vacuum grippers, magnetic grippers, and mechanical gripping systems, or combinations thereof.

In embodiments, a system, such as a forming plant, is provided that comprises at least one robotic system according to one of the embodiments described herein and one or more forming machines, such as forging machines or presses, for forming workpieces, in particular for forging or pressing. The at least one robotic system is arranged and configured to feed workpieces, in particular blanks, to at least one of the forming machines.

In embodiments of the system, it may further comprise a supply area for workpieces, such as a container or a box. The robotic system may be arranged to pick up workpieces from the supply area using the end effector or end-effector system and feed them to the forming machine for processing or forming by the forming machine.

The workpieces may be available in the supply area, for example in a container or a box, either sorted or unsorted.

Consequently, the system may be configured as a forming machine with a bin-picking device that can be implemented by the robotic system. Furthermore, it is possible for the robotic system to be configured and arranged as a bin-picking robotic system that enables workpieces to be retrieved from a supply area, e.g., from a container or a box, wherein the workpieces may be sorted or unsorted.

Below, exemplary embodiments of the invention are described with reference to the accompanying figures. In the figures, identical components and components performing the same function are designated by the same reference signs. Shown schematically are:

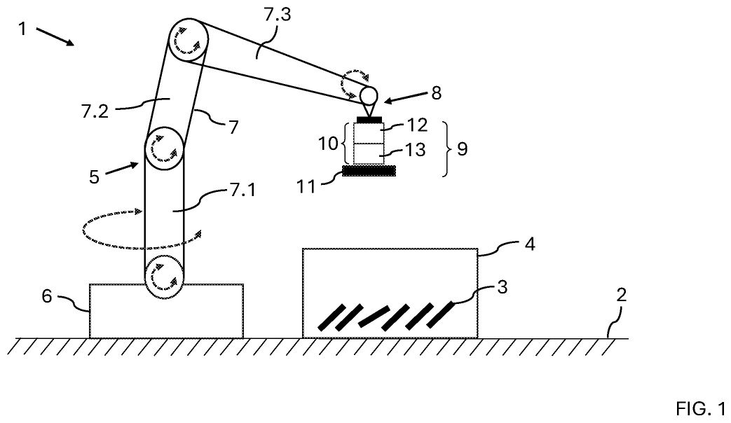

FIG. 1 a robotic system comprising an end-effector system with an adaptive connection module;

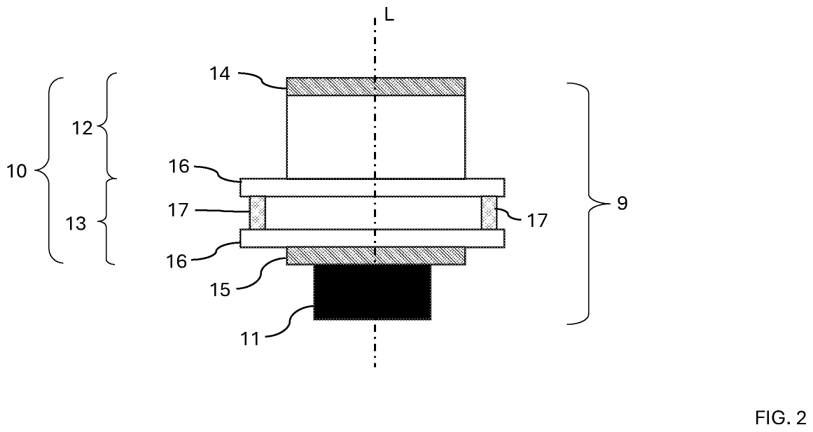

FIG. 2 the end-effector system;

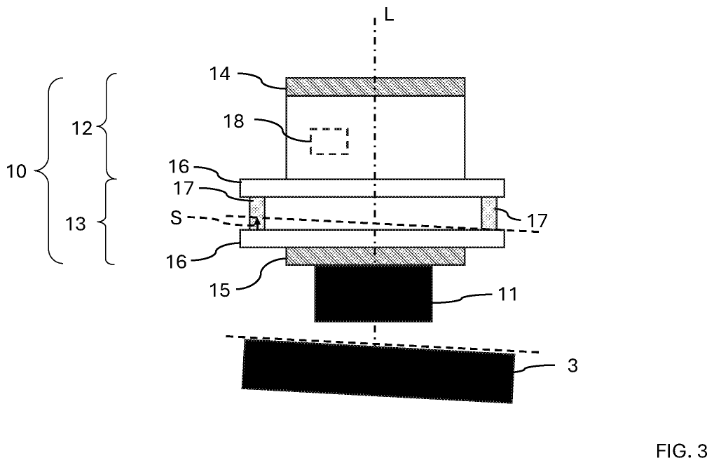

FIG. 3 the adaptive connection module;

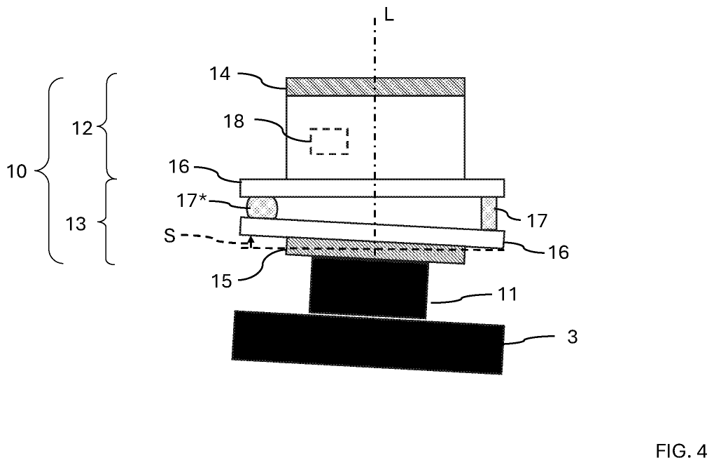

FIG. 4 the adaptive connection module in an operating state relating to the compliance unit; and

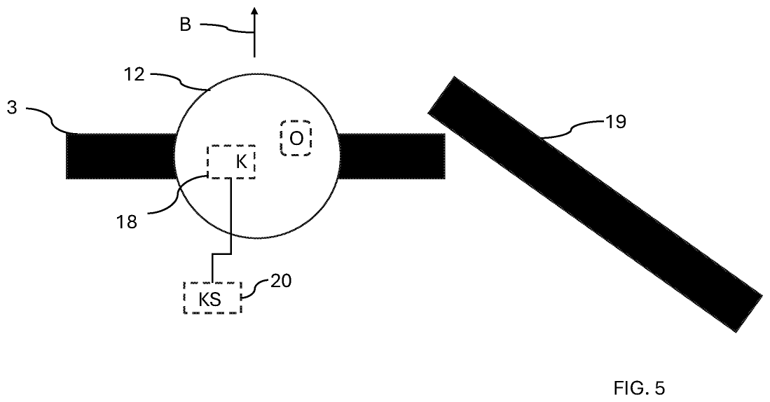

FIG. 5 a top view of the adaptive connection module in an operational state relating to the collision protection unit.

FIG. 1 shows a robotic system 1, which in this example is configured as a so-called bin-picking system. The robotic system 1 is mounted on a base 2 and is arranged to remove workpieces 3, e.g., metal blanks for further processing such as forming or forging, from a container 4 or a box and to feed them, for example, to a (not shown) feeder leading to a processing machine, or directly to the processing machine.

The robotic system 1 comprises a robot 5, specifically an industrial robot, having a robot arm 7 mounted on a pedestal 6 so as to rotate about a vertical axis; in the present example (and without limitation), the robot arm 7 comprises three arm segments 7.1 to 7.3, each of which is mounted on the adjacent segment so as to rotate relative to it (dashed double arrows). The robot arm 7 is therefore a multiaxial robot arm.

The robot arm 7 has an attachment flange or other attachment elements at its distal end 8, which are arranged for mounting an end-effector system 9.

In the present example, the end-effector system 9 comprises an adaptive connection module 10 and an end effector 11, which may be, for example, a magnetic gripper, a vacuum gripper, a mechanical gripper, or a combination thereof. The adaptive connection module 10, in turn, comprises a collision protection unit 12 and a compliance unit 13.

FIG. 2 shows an example of an end-effector system 9 in detail. The adaptive connection module 10, comprising a collision protection unit 12 and a compliance unit 13, is arranged in series along the longitudinal axis L; in this example, and in conjunction with FIG. 1, starting from the distal end 8, the compliance unit 13 is arranged immediately downstream of the collision protection unit 12. An arrangement in the reverse order is also possible.

More specifically, the collision protection unit 12 comprises a first mounting interface 14, and the compliance unit 13 comprises a second mounting interface 15. When assembled, the adaptive connection module 10 is mounted via the first mounting interface 14 to the attachment flange of the distal end 8 of the robot arm 7 (e.g., via screw connections). Furthermore, the end effector 11 is mounted to the second mounting interface 15 (e.g., via screw connections). Consequently, the adaptive connection module 10 is interposed between the distal end 8 of the robot arm 7 and the end effector 11, with the collision protection unit 12 and the compliance unit 13 connected in series.

In the example shown in FIG. 2, the compliance unit 13 comprises two plate bodies 16 spaced apart from one another in the direction of the longitudinal axis L and (in the unloaded state) extending substantially parallel to one another, which are connected to one another by means of elastomer bodies and/or spring bodies 17. In the example shown in FIG. 2, only two such elements 17 are shown. However, the number and arrangement of the elements 17 may vary depending on the compliance requirements and, for example, the desired elasticity modulus and/or spring modulus. Suitable elastomer elements include, for example, rubber elements or rubber buffers.

FIG. 3 shows the adaptive connection module of FIG. 2. The collision protection unit 12 comprises a sensor unit 18 (shown only schematically). The sensor unit is arranged to recognize forces (which act on the adaptive connection module 10 via the mounting interfaces 14, 15 and enter the adaptive connection module, and which are characteristic of a collision event between the end effector 11 and an external object or obstacle), mechanical moments, movements, changes in pose, and/or changes in position. The mechanical moments may, for example, be rotational, tilting, and/or bending forces or moments. To determine collision events based on movements, changes in pose, and/or changes in position, relative and/or absolute changes may be considered, which can be determined, for example, by means of displacement measurement systems, proximity sensors, and/or proximity switches.

The compliance unit 13 provides adaptive coupling between the first and second mounting interfaces 14, 15 via the elastic bodies and/or spring bodies 17. This adaptive coupling allows the pose and/or orientation of the end effector 11 to be adjusted relative to the distal end 8 of the robot arm 7 and, consequently, relative to the workpiece 3, for example, when a workpiece 3 to be gripped or picked up by the end effector 11 during a bin-picking operation, i.e., when performing the extraction of the workpiece 3 from the container 4, the workpiece 3 and the end effector 11 are not optimally oriented with each other.

This is exemplary illustrated in FIG. 3 by dashed lines. In the example shown in FIG. 3, the workpiece 3 is oriented at a slight angle to the end effector, which may be caused, for example, by inaccuracies in determining the position or pose of the workpiece 3 based on optical sensors.

If the end effector 11 is now moved downward toward the workpiece 3 by a downward movement of the robot arm 7, the elastomer bodies and/or spring bodies 17 allow the plate bodies 16 to tilt relative to one another, for example by elastically compressing(S) one or more of the elastomer bodies and/or spring bodies 17. The state with elastic compression S is shown schematically in FIG. 4. The compliance unit 13 allows the second mounting interface 15, and thus the end effector 11, to orient in such a way that the workpiece 3 can be securely gripped by the end effector 11. Once the forces or moments causing the compression S have ceased, the compressed elastomer bodies and/or spring bodies 17* return to their original shape due to their elastic resetting properties, so that the plate bodies 16 are again substantially parallel to one another.

FIG. 5 shows a schematic top view of the adaptive connection module 10 in an operating state with respect to the collision protection unit 12. FIG. 5 illustrates that the end-effector system 9, holding a workpiece 3, is performing a movement B (upward in the example shown in FIG. 5). An external object 19, e.g., an additional workpiece 3 located in the container 4, is situated in the path of movement of the workpiece 3. If the workpiece 3 now encounters the external object 19 during movement B, the sensor unit 18 of the collision protection unit 13 generates a collision signal K when forces and/or mechanical moments characteristic of a collision are recognized. The collision signal K is generated when a force acting on the adaptive connection module 10 via the mounting interfaces 14, 15 and/or a moment acting on the adaptive connection module 10 via the mounting interfaces 14, 15 exceeds a prescribed or prescribable threshold. The threshold can, for example, be determined based on a maximum moment that the robot arm 7 can absorb without damage or a maximum force that it can absorb without damage.

A signal processing unit 20 (shown only schematically in FIG. 5) may be associated with the sensor unit 18; this unit is arranged to generate and provide a control or steering signal KS in response to a collision event detected for the end effector 11 (e.g., based on the collision signal K). The control or steering signal KS is adapted and is preferably processed, for example by the signal processing unit 20 or, for example, a further (not shown) control or steering unit of the robot system 1, such that it causes an immediate stop of the current movement B of the robot arm 7, and preferably causes the robot arm to move to the initial position. In embodiments, the control or steering signal KS may cause or be processed such that the robot arm 7 assumes an initial position of a cyclic movement or a portion of a cyclic movement, and, starting from the initial position (or reset position), performs at least a portion of a cyclic movement.

Optionally, the adaptive connection module 10 may further comprise one or more optical sensors O, such as cameras or camera systems and the like, which are positioned and configured such that, when the adaptive connection module 10 is mounted on the distal end 8 of the robot arm 7, environmental objects can be detected and/or recognized during normal operation, and/or the position, orientation, and/or pose of a workpiece 3 to be handled by the end effector 11 can be detected and/or determined. The detected position, orientation, and/or pose can be used by a control or steering unit to control the movement of the robot arm 7. Optical sensors may also, or alternatively, be mounted in a stationary position relative to the container 4 from which the workpieces 3 are to be removed.

The robotic system 1 may comprise at least one (not shown) control or steering unit that is signal-connected to the sensor unit 18. The sensor unit 18 may be arranged to generate the collision signal K and provide it to the control or steering unit upon a recognized or detected collision event, particularly one occurring during movement of the robot arm 7. The control or steering unit may be arranged to stop the movement of the robot arm 7 and/or to control the robot arm 7 and the end effector 11 into a prescribed initial position in response to receiving the collision signal K. The control or steering unit may further be arranged to, after controlling the robot arm 7 into the prescribed initial position, control a further movement process or movement cycle of the robot arm 7 starting from the initial position. The control or steering unit may comprise the signal processing unit 20 or vice versa, and/or the control or steering unit may be part of the signal processing unit 20 or vice versa.

Overall, it is evident that the invention proposed herein solves the underlying problem.

Further embodiments of the present invention may be summarized as follows. Any of these embodiments can be claimed in a separate claim, e.g. by substituting the word “Embodiment” by “Claim”, in particular in the order as mentioned below and/or in any combination with any embodiment described above or with any of the features of the attached claims.

Embodiment 1: Adaptive connection module 10 for robot arms 7, which is arranged for mounting between a robot arm 7 and an end effector 11 to be moved by the robot arm 7, such as a mechanical, pneumatic, and/or magnetic gripper, for gripping, or holding and/or handling an object 3, in particular a workpiece 3, comprising a collision protection unit 12, a compliance unit 13 connected in series therewith, a first mounting interface 14 associated with the collision protection unit 12, and a second mounting interface 15 associated with the compliance unit 13, wherein:
a) the mounting interfaces 14, 15 are configured such that the adaptive connection module 10 is to be connected to a distal end 8 of the robot arm 7 via one of the mounting interfaces 14 and to the end effector 11 via the other mounting interface 15, and the collision protection unit 12 and the compliance unit 13 are connected in series between the distal end 8 of the robot arm 7 and the end effector 11,
b) the collision protection unit 12 comprises a sensor unit 18 that is arranged to detect forces and/or mechanical moments acting on the adaptive connection module 10 via the mounting interfaces 14, 15 and characteristic of a collision event at the end effector 11, in particular rotational, tilting, and/or bending forces or moments, and/or changes in pose, changes in position, and/or movements characteristic of a collision event; and
c) the compliance unit 13 provides adaptive coupling between the mounting interfaces 14, 15.

Embodiment 2: Adaptive connection module 10 according to embodiment 1, wherein the sensor unit 18 is arranged to generate a collision signal when forces, mechanical moments, changes in pose, changes in position, and/or movements characteristic of a collision are recognized, wherein the collision signal is generated when a force acting on the adaptive connection module 10 via the mounting interfaces 14, 15, a moment acting on the adaptive connection module 10 via the mounting interfaces 14, 15, changes in pose, changes in position, and/or movements of the adaptive connection module, in particular of the collision protection unit, exceed a prescribed or prescribable threshold.

Embodiment 3: Adaptive connection module 10 according to embodiment 1 or 2, further comprising a signal processing unit 20 arranged to generate and provide a control or steering signal K, KS in response to a collision event detected for the end effector 11.

Embodiment 4: Adaptive connection module 10 according to embodiment 3, wherein the control or steering signal K, KS is adapted in such a way that it:
signals or represents a command for an immediate stop of a current movement of the robot arm 7, and/or
signals or represents a command for a movement of the robot arm 7 to an initial position, and/or
signals or represents a command for a movement of the robot arm 7 to an initial position of a cyclic movement or a part of a cyclic movement of the robot arm 7, and signals or represents a command to repeat, in particular adaptively repeat, the movement of the robot arm 7 starting from the initial position.

Embodiment 5: Adaptive connection module 10 according to any of the preceding embodiments, wherein the compliance unit 13 comprises one or more elastic and/or fluidic, in particular elastically and/or fluidically resetting, compensation units or compensation bodies 17.

Embodiment 6: Adaptive connection module 10 according to any of the preceding embodiments, wherein the collision protection unit 12 comprises a mechanical trigger element which, upon the application of a collision moment, causes a displacement opposite to the collision moment, in particular an elastic or fluidic, preferably self-resetting, displacement and/or decoupling of the two mounting interfaces 14, 15.

Embodiment 7: End-effector system 9 for a robot 5 comprising at least one adaptive connection module 10 according to any of embodiments 1 through 6, wherein the first mounting interface 14 is preferably configured for mounting on a distal end 8 of a robot arm 7 of the robot 5 and the second mounting interface 15 is preferably configured for mounting an end effector 11.

Embodiment 8: End-effector system 9 for a robot 5 according to embodiment 7, further comprising an end effector 11 that is preferably mounted at the second mounting interface 15.

Embodiment 9: Robotic system 1 comprising at least one robot 5 having a robot arm 7 with a distal end 8, to which, via an adaptive connection module 10 according to any of embodiments 1 through 6, an end effector 11 is mounted, or to which an end-effector system 9 according to any of embodiments 7 through 8 is mounted.

Embodiment 10: Robotic system 1 according to embodiment 9, comprising at least one control or steering unit, wherein the control or steering unit 20 is signal-connected to the sensor unit 18, wherein the sensor unit 18 is arranged to generate a collision signal K upon recognition or detection of a collision event, particularly one occurring during movement of the robot arm 7, and provide it to the control or steering unit 20, and wherein the control or steering unit 20 is arranged, in response to receiving the collision signal K, to stop the movement of the robot arm 7 and/or to move the robot arm 7 and the end effector 11 to a prescribed initial position.

Embodiment 11: Robotic system 1 according to embodiment 10, wherein the control or steering unit 20 is further arranged to, after controlling the robot arm 7 into the prescribed initial position, control a further movement process or movement cycle of the robot arm 7 starting from the initial position.

Embodiment 12: Robotic system 1 according to any of embodiments 9 through 11, wherein the robotic system 1 is arranged as a bin-picking system for the extraction of an object, in particular a workpiece 3, from a container 4.

Embodiment 13: Robotic system 1 according to any of embodiments 9 through 12, wherein the end effector 11 comprises one or more mechanical, pneumatic, and/or magnetic handling units, in particular grippers or gripping arrangements.

Embodiment 14: System comprising at least one robotic system 1 according to any of embodiments 9 through 13 and one or more forming machines for forming, in particular for forging or pressing, workpieces 3, wherein the at least one robotic system 1 is arranged to feed workpieces 3, in particular blanks, to at least one of the forming machines.

Embodiment 15: System according to embodiment 14, further comprising a supply area for the workpieces 3, wherein the robotic system 1 is arranged to pick up workpieces in the supply area using the end effector 11 or end-effector system 9 and feed them to the forming machine for processing, wherein the workpieces 3 are present in the supply area, preferably in a container or a box, in particular sorted or unsorted.

### LIST OF REFERENCE SIGNS

1 robotic system
2 base
3 workpiece
4 container, bin
5 robot
6 pedestal
7 robot arm
7.1-7.3 arm segments
8 distal end
9 end-effector system
10 adaptive connection module
11 end effector
12 collision protection unit
13 compliance unit
14 first mounting interface
15 second mounting interface
16 plate body
17 elastomer body and/or spring body
18 sensor unit
19 external object
20 signal processing unit
B movement
L longitudinal axis
O optical sensor
S compression

1. Adaptive connection module for robot arms, which is arranged for mounting between a robot arm and an end effector to be moved by the robot arm, such as a mechanical, pneumatic, and/or magnetic gripper, for gripping, or holding and/or handling an object, in particular a workpiece, comprising a collision protection unit, a compliance unit connected in series therewith, a first mounting interface associated with the collision protection unit, and a second mounting interface associated with the compliance unit, wherein:
a) the mounting interfaces are configured such that the adaptive connection module is to be connected to a distal end of the robot arm via one of the mounting interfaces and to the end effector via the other mounting interface, and the collision protection unit and the compliance unit are connected in series between the distal end of the robot arm and the end effector,
b) the collision protection unit comprises a sensor unit that is arranged to detect forces and/or mechanical moments acting on the adaptive connection module via the mounting interfaces and characteristic of a collision event at the end effector, in particular rotational, tilting, and/or bending forces or moments, and/or changes in pose, changes in position, and/or movements characteristic of a collision event; and
c) the compliance unit provides adaptive coupling between the mounting interfaces.

2. Adaptive connection module according to claim 1, wherein the sensor unit is arranged to generate a collision signal when forces, mechanical moments, changes in pose, changes in position, and/or movements characteristic of a collision are recognized, wherein the collision signal is generated when a force acting on the adaptive connection module via the mounting interfaces, a moment acting on the adaptive connection module via the mounting interfaces, changes in pose, changes in position, and/or movements of the adaptive connection module, in particular of the collision protection unit, exceed a prescribed or prescribable threshold.

3. Adaptive connection module according to claim 1, further comprising a signal processing unit arranged to generate and provide a control or steering signal in response to a collision event detected for the end effector.

4. Adaptive connection module according to claim 3, wherein the control or steering signal is adapted in such a way that it:
signals or represents a command for an immediate stop of a current movement of the robot arm, and/or
signals or represents a command for a movement of the robot arm to an initial position, and/or
signals or represents a command for a movement of the robot arm to an initial position of a cyclic movement or a part of a cyclic movement of the robot arm, and signals or represents a command to repeat, in particular adaptively repeat, the movement of the robot arm starting from the initial position.

5. Adaptive connection module according to claim 1, wherein the compliance unit comprises one or more elastic and/or fluidic, in particular elastically and/or fluidically resetting, compensation units or compensation bodies.

6. Adaptive connection module according to claim 1, wherein the collision protection unit comprises a mechanical trigger element which, upon the application of a collision moment, causes a displacement opposite to the collision moment, in particular an elastic or fluidic, preferably self-resetting, displacement and/or decoupling of the two mounting interfaces.

7. Robotic system comprising at least one robot having a robot arm with a
(i) to which, via an adaptive connection module according to claim 1, an end effector is mounted, or
(ii) to which an end-effector system is mounted, the end-effector system comprising at least one adaptive connection module according to claim 1, wherein the first mounting interface is preferably configured for mounting on a distal end of a robot arm of the robot and the second mounting interface is preferably configured for mounting an end effector, optionally further comprising an end effector that is preferably mounted at the second mounting interface.

8. Robotic system according to claim 7, comprising at least one control or steering unit, wherein the control or steering unit is signal-connected to the sensor unit, wherein the sensor unit is arranged to generate a collision signal upon recognition or detection of a collision event, particularly one occurring during movement of the robot arm, and provide it to the control or steering unit, and wherein the control or steering unit is arranged, in response to receiving the collision signal, to stop the movement of the robot arm and/or to move the robot arm and the end effector to a prescribed initial position.

9. Robotic system according to claim 8, wherein the control or steering unit is further arranged to, after controlling the robot arm into the prescribed initial position, control a further movement process or movement cycle of the robot arm starting from the initial position.

10. Robotic system according to claim 7, wherein the robotic system is arranged as a bin-picking system for the extraction of an object, in particular a workpiece, from a container.

11. Robotic system according to claim 7, wherein the end effector comprises one or more mechanical, pneumatic, and/or magnetic handling units, in particular grippers or gripping arrangements.

12. System comprising at least one robotic system according to claim 7 and one or more forming machines for forming, in particular for forging or pressing, workpieces, wherein the at least one robotic system is arranged to feed workpieces, in particular blanks, to at least one of the forming machines.

13. System according to claim 12, further comprising a supply area for the workpieces, wherein the robotic system is arranged to pick up workpieces in the supply area using the end effector or end-effector system and feed them to the forming machine for processing, wherein the workpieces are present in the supply area, preferably in a container or a box, in particular sorted or unsorted.
